(19) United States
(12) Patent Application Publication
(10) Pub. No.: US 2022/0408748 A1
(43) Pub. Date: Dec. 29, 2022

(54) ANALOGUE PIZZA CHEESE WITH IMPROVED FREEZE/THAW STABILITY

(71) Applicant: General Mills, Inc., Minneapolis, MN (US)

(72) Inventors: James Fudge, Champlin, MN (US); Matthew Larsen, Maple Grove, MN (US); Joshua Hemann, Big Lake, MN (US); Wenyi Wang, Blaine, MN (US); Aaron Wlaschin, St. Paul, MN (US); Michelle Manderfeld, Plymouth, MN (US); Brent Wyrick, Richfield, MN (US); Molley Glidden, Crystal, MN (US)

(21) Appl. No.: 17/592,872

(22) Filed: Feb. 4, 2022

Related U.S. Application Data
(60) Provisional application No. 63/216,381, filed on Jun. 29, 2021.

(51) Int. Cl. A23C 20/00; A23C 19/093; A23C 19/068; A21D 13/41

(52) U.S. Cl. CPC A23C 20/00; A23C 19/093; A23C 19/0684; A21D 13/41

(57) ABSTRACT

A pizza cheese composition may include a dairy cheese and analogue cheese. The dairy cheese can provide at least 10 weight percent of the pizza cheese composition. The analogue cheese may include one or more fats, casein protein, guar gum, and one or more hydrocolloid other than guar gum. The fat can range from 15 to 35 weight of the analogue cheese and be obtained from a non-dairy source. The casein protein can be present in an amount less than 3 weight percent of the analogue cheese. The hydrocolloid other than guar gum may range from 10 to 25 weight percent of the analogue cheese. An example specifies that a ratio of a weight of guar gum divided by a weight of casein protein is at least 1.0. This can provide enhanced freeze/thaw stability notwithstanding the reduced levels of casein protein used in the composition.

### RELATED MATTERS

This application claims the benefit of U.S. Provisional Patent Application No. 63/216,381, filed Jun. 29, 2021, the entire contents of which are incorporated herein by reference in their entirety.

### TECHNICAL FIELD

This disclosure relates to analogue cheese compositions and, more particularly, to analogue pizza cheese compositions.

### BACKGROUND

Cheese is widely used in frozen foods and readymade conventional meals. For example, cheese is an essential component in frozen pizzas and other cheese-containing hot snacks. The costs associated with natural cheese, seasonal price fluctuation, and storage requirements have prompted the food industry to search for alternatives to natural cheese. Analogue cheese compositions are one solution to the challenges of using natural cheese. Analogue cheese compositions are generally described as compositions that look like natural cheese and have a taste profile similar to natural cheese but in which constituents including milk fat have been partly or completely replaced by other ingredients. Milk fat is typically substituted with vegetable fat to formulate an analogue cheese.

Analogue cheese compositions generally include casein. Casein is a protein naturally found in milk that helps provide the functional characteristics found in the majority of natural cheese varieties. While casein provides desired functional properties in the formulation of analogue cheese compositions, casein can be a challenging ingredient for food manufacturers. Casein is one of the most expensive ingredients, if not the most expensive single ingredient, used in an analogue cheese composition. Moreover, the available supply of casein is limited. During periods of significant demand increase for cheese-containing products, food manufacturers can experience casein shortages that limit their product analogue cheese compositions.

For these and other reasons, food manufacturers may attempt to reduce the amount of casein used in an analogue cheese formulation. But reducing or replacing a conventional analogue cheese composition ingredient such as casein protein can present many expected or unexpected technical hurdles. Analogue cheese compositions are complex compositions and their properties can be sensitive to the presence of certain ingredients, in functional amounts. Changing the amount of even one ingredient, such as casein, traditionally used in an analogue cheese composition can cause undesirably changes in the structure and properties of the cheese.

### SUMMARY

In general, this disclosure is directed to pizza cheese compositions that include a natural or dairy cheese component and an analogue cheese component. The pizza cheese composition includes a majority of the analogue cheese component and a lesser amount of the dairy cheese component. The analogue cheese component is formulated with a reduced relative amount of casein protein. For example, the analogue cheese component may be formulated with less than three weight percent casein protein, less than one weight percent casein protein, or, in some specific implementations, may be entirely devoid of casein protein.

In practice, it has been identified that reducing the amount of casein protein present in the analogue cheese component of the pizza cheese composition can undesirably impact the freeze/thaw stability of the analogue cheese component. In general, the freeze/thaw stability of the analogue cheese component refers to how well the analogue cheese maintains its properties after undergoing at least one cycle of being frozen and then thawed as compared to those same properties exhibited by the cheese prior to being frozen. For example, the firmness of the analogue cheese typically deteriorates after being frozen and thawed as compared to the firmness of the cheese prior to being frozen. Reducing the amount of casein protein present in the analogue cheese has been found to exacerbate the freeze/thaw stability of the cheese as compared to a comparable analogue cheese with increased amount of casein protein.

Food manufacturers desire that analogue cheese compositions exhibit adequate freeze/thaw stability to ensure the processability of the analogue cheese. In practice, a food manufacturer may manufacture or source an analogue cheese but not incorporate the analogue cheese into a food product immediately upon production. Rather, the analogue cheese may be frozen after being manufactured (e.g., for storage and/or transport) and later thawed when ready to be used in the production of a food product. Often, the analogue cheese is produced in the form of a cheese block that is frozen. The frozen cheese block may later be thawed in size reduced, for example by dicing or shredding. If the thawed cheese block does not exhibit sufficient textural firmness, the thawed cheese block can be challenging to size reduce, exhibiting inconsistent shearing characteristics and/or having a tendency to plug size reducing equipment. Other characteristics of the analogue cheese, such as those detected by the end consumer, may also be impacted by freeze/thaw cycling of the analogue cheese.

In accordance with some examples of the present disclosure, applicant has identified that addition of an effective amount of guar gum to an analogue cheese composition formulated with a reduced amount of casein protein can reduce or eliminate freeze/thaw instability caused by reducing the amount of casein protein in the cheese. The amount of guar gum added to the analogue cheese composition can be provided as a ratio relative to the amount of casein protein present in the cheese composition. For example, the amount of guar gum added to the analogue cheese may be increased proportionately to the amount of casein protein remove from the analogue cheese, thereby proportionately counteracting the freeze/thaw impact associated with the reduced amount of casein protein.

Without wishing to be bound by any particular theory, it is believed that guar gum may function to bind water around fat droplets in the analogue cheese composition, helping to stabilize the water molecules through freeze/thaw cycling. Since casein protein exhibits emulsifying properties to help emulsify and stabilize water and oil ingredients used in the analogue cheese composition, reducing the amount of casein protein present in the analogue cheese may lead to increased water separation and concomitant freeze/thaw instability. Adding an increased amount of guar gum to the formulation can help counteract this freeze/thaw instability. Moreover, as will be described, guar gum has been found to be unexpectedly good at improving the freeze/thaw stability of an analogue cheese composition with a reduced amount of casein protein as compared to other candidate freeze/thaw stabilizing agents. In some implementations, addition of guar gum can increase the textural firmness of the analogue cheese after having undergone a freeze/thaw cycle over 50% compared to a control sample without the elevated levels of guar gum.

In addition to or in lieu of adding an effective amount of guar gum to the analogue cheese composition to control freeze/thaw stability, an analogue cheese composition according to the disclosure may be manufactured to have reduced relative levels of casein protein and increased relative levels of emulsifying salts. Increasing the amount of emulsifying salts used in the analogue cheese composition may be useful to improve the functionality of the remaining casein protein present in the analogue cheese. For example, increasing the relative amount of emulsifying salt used in the analogue cheese composition while reducing the amount of casein protein present may cause the residual casein protein to unfold more fully in the cheese composition. As a result, the residual casein protein may impart functional properties to the analogue cheese corresponding to a higher casein protein concentration albeit at a lower level. This can allow the relative amount of casein protein present in the analogue cheese composition to be reduced while minimizing the performance degradation associated with reducing the casein protein level by increasing the amount of emulsifying salt present in the composition.

In one example, a pizza cheese composition is described that includes a dairy cheese and analogue cheese. The dairy cheese provides at least 10 weight percent of the pizza cheese composition. The example specifies that the analogue cheese includes one or more fats, casein protein, guar gum, and one or more hydrocolloid other than guar gum. The fat ranges from 15 to 35 weight of the analogue cheese and is obtained from a non-dairy source. The casein protein is present in an amount less than 3 weight percent of the analogue cheese. The hydrocolloid other than guar gum ranges from 10 to 25 weight percent of the analogue cheese. The example specifies that a ratio of a weight of guar gum divided by a weight of casein protein is at least 1.0.

In another example, a pizza cheese composition is described that includes a dairy cheese ranging from 10 to 20 weight percent of the pizza cheese composition and an analogue cheese ranging from 80 to 90 weight percent of the pizza cheese composition. The example specifies that the analogue cheese includes one or more fats, casein protein, guar gum, one or more hydrocolloids other than guar gum, water, and one or more emulsifying salts. According to the example, fat ranges from 15 to 35 weight of the analogue cheese and is obtained from a non-dairy source. The casein protein his present in an amount less than 3 weight percent of the analogue cheese. The hydrocolloid other than guar gum ranges from 10 to 25 weight percent of the analogue cheese and is at least 75 weight percent of a starch. Water ranges from 33 to 55 weight percent of the analogue cheese. According to the example, a ratio of a weight of guar gum divided by a weight of casein protein is at least 1.0, and ratio of a weight of emulsifying salt divided by a weight of casein protein ranges from 2 to 4.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a plot of experimental data showing freeze/thaw textural firmness for example cheese compositions.

FIG. 2 is a plot of experimental data showing temperature stability for an example cheese composition.

FIGS. 3A-3C are graphs illustrating the results of experiment modifying the amount of emulsifying salts added to the pizza cheese.

### DETAILED DESCRIPTION

This disclosure generally relates to analogue cheese compositions, pizza cheese compositions incorporating the analogue cheese, food products incorporating analogue cheese and/or pizza cheese, and associated methods in which the analogue cheese and/or pizza cheese is formulated with a relatively reduced amount of casein protein. In some implementations, a pizza cheese composition includes a dairy cheese fraction and an analogue cheese fraction. The dairy cheese fraction may constitute a comparatively small proportion of the pizza cheese composition, such as from 10 to 20 weight percent of the pizza cheese composition, with the remainder of the pizza cheese composition being provided by the analogue cheese fraction. The analogue cheese fraction may be formulated with a limited amount of casein protein or, in other examples, may not include any added casein protein. Reduced casein protein levels in the analogue cheese may deteriorate the functional properties of the analogue cheese. In accordance with examples of the present disclosure, other constituent components may be added to the analogue cheese and/or the relative weight percentages of a constituent component may be adjusted to counteract the reduced performance of the analogue cheese caused by reducing the casein protein loading.

In some examples, a reduced casein protein analogue cheese is described that includes a controlled amount of guar gum. For example, the analogue cheese may have less than three weight percent casein protein, less than two weight percent casein protein, or less than one weight percent casein protein. The amount of guar gum added to the analogue cheese may be greater than or equal to the amount of casein protein added to the analogue cheese. For example, a ratio between the amount of guar gum and the amount of casein protein added to the analogue cheese may be greater than one, such as greater than 2.0. Utilizing an increased amount of guar gum relative to a reduced amount of casein protein in the analogue cheese can help maintain various target functional properties of the cheese, such as freeze/thaw stability properties.

A pizza cheese composition as described herein can include a threshold amount of a natural or dairy cheese and a remaining amount of an analogue cheese. While any one or more dairy cheeses can be used in the pizza cheese composition, dairy mozzarella cheese may be most commonly utilized in the pizza cheese composition. The addition of the dairy cheese component to the pizza cheese composition can change the characteristics of the pizza cheese as compared to if the pizza cheese were otherwise entirely formulated from the analogue cheese. As a result, the functional properties of the cheese, such as freeze/thaw stability, may be impacted not only by the composition of the analogue cheese but also the relative amount of the dairy cheese combined with the analogue cheese to form the resultant pizza cheese composition. The amount of guar gum desirably added to the analogue cheese may therefore be affected not only by the reduced level of casein protein utilized in the analogue cheese but also by the amount of dairy cheese used to arrive at a pizza cheese composition exhibiting targeted freeze/thaw stability.

As used herein, the following terms used in the application have the following meanings:

An “analogue cheese” as used herein refers generally to a cheese in which a milk fat and/or a protein source has been substituted with a source that is not native to milk. Cheese analogues are typically categorized as dairy, partial dairy, or nondairy, depending on whether the fat and/or dairy components are from dairy or vegetable sources. They can also be classified as being an imitation cheese or a substitute cheese. Imitation cheese is a substitute for and resembles another cheese but is nutritionally inferior to that cheese. A cheese substitute, on the other hand, resembles another cheese but is not nutritionally inferior to that cheese.

A “dairy cheese” as used herein refers to a natural cheese composition made directly from milk that meets specific United States Department of Agriculture (USDA) standards specified for natural cheese compositions, including ingredients used, manufacturing procedures used, and final nutritional value. For example, the requirements for mozzarella cheese are provided by 21 C.F.R. §§ 1.33.155-133.158.

A “Freeze/Thaw Evaluation Cycle” as used herein means filing a plastic crate having a length×width×height of 18.75 inches×11.75 inches×8.5 inches tall with a hot cheese composition, with the cheese composition first being filled in a plastic bag that is then closed before being placed in the plastic crate. The plastic crate is then placed in a freezer at −10° F. for 24 hours. After the center of the cheese block reaches a temperature of at least 27° F., the plastic crate is transferred to a cooler set at 40° F. for three days to thaw. The compressibility of the cheese block is then tested using a TA.XT.plus Texture Analyzer and a TA-40 probe. A cylindrical sample of cheese is obtained measuring ⅞ of an inch in diameter and ⅞ of an inch in length. The starting height of probe on the texture analyzer is set at 19 mm. The target mode for the test is strain with a target strain of 50% for a time of 0.1 seconds. The force threshold is set at 10. The trigger type is force, and the trigger force is 5.0 g. The speed of the test setpoint is 2.00 mm/sec.

In general, pizza cheese compositions are described that include a dairy cheese and an analogue cheese. The analogue cheese may include casein protein, fat, water, and a variety of other optional additives, such as structure builders, colorants, flavorants, preservatives, etc. The amount of casein protein added to the analogue cheese may be relatively reduced to provide a low casein analogue cheese composition. The described analogue cheese compositions are non-natural cheese compositions (e.g., imitation cheese compositions) that include a relatively reduced amount of casein protein when compared to otherwise comparable cheese compositions, while providing functional, organoleptic, and/or nutritional properties that are suitable notwithstanding the reduced level of casein protein.

In some examples, the analogue cheese includes guar gum in an amount set relative to the amount of casein protein present in the analogue cheese. The guar gum can counteract functional property deterioration of the analogue cheese, particulate freeze/thaw stability, caused by reducing the amount of casein protein that may otherwise be present in the analogue cheese. Additionally or alternatively, the analogue cheese may include one or more emulsifying salts. The amount of emulsifying salt, when used in the analogue cheese composition, may also be provided in an amount set relative to the amount of casein protein present in the analogue cheese. Increased amounts of emulsifying salt in the analogue cheese may drive enhanced functionality from the residual casein protein present in the analogue cheese, as compared to the functionality otherwise provided when using lower amounts of emulsifying salt.

The analogue cheese composition can include a fat ingredient of a type and in an amount to provide desired functional properties in the resultant cheese. The type and amount of fat can affect properties of the analogue cheese, and resulting pizza cheese composition, such as melt, crumble, stretch, firmness, final texture, etc. Fat ingredients are commonly and synonymously referred to as a fat, shortening, or oil. Fat can be either liquid or solid at room temperature, or a combination of liquid and solid at room temperature (e.g., semisolid).

Fat ingredients typically used in analogue cheese compositions typically include vegetable fat, dairy fat, and combinations thereof. Dairy fat may be used in analogue cheese compositions that dairy or partial dairy analogues. In some compositions, however, the analogue cheese is formulated as a nondairy analogue cheese that does not utilize fat extracted or otherwise derived from a dairy source. In these compositions, the fat ingredient may be provided entirely from (e.g., consist essentially of, or consist of) non-diary fat, such as vegetable fat.

Exemplary fat ingredients include all vegetable fats and oils, individual ingredients or blends thereof, fractionated, interesterified, or fully hydrogenated. Examples of such fat ingredients include hydrogenated coconut oil, cottonseed oil, soybean oil, groundnut oil, palm oil, palm kernel oil, corn oil, canola oil, safflower oil and combinations thereof

In general, a useful amount of fat in a described analogue cheese composition can include an amount that provides suitable properties such as cheese composition flavor, texture, processing, stability, and melting properties. Such an amount can be in a range from about 15 to about 35 weight percent fat based on total weight of the analogue cheese composition, such as from about 20 to about 30 weight percent fat based on the total weight of the analogue cheese composition.

The analogue cheese composition can include one or more protein sources, including casein protein. Protein can influence functional, organoleptic, and nutritional properties of a cheese composition. Protein generally forms a three-dimensional network within a cheese composition and can influence melt, stretch, machinability, depositing performance, freeze/thaw stability, pizza bake performance, taste, and color characteristics of a cheese composition. Protein can also influence nutritional characteristics. Proteins that can be used in the analogue cheese composition include dairy proteins like casein protein, non-casein dairy proteins, and non-dairy proteins such as vital wheat gluten protein.

Casein protein is an edible protein that can be found naturally in milk and that is conventionally known to provide many important characteristics in cheese compositions. Casein protein is conventionally understood to be at least in part responsible for certain desired functional and organoleptic properties of a cheese composition. As used herein, the term “casein protein” means casein in all its forms, including rennet casein, acid casein, caseinate derivatives, fresh cheese, and dehydrated cheese. One specific form of casein protein is rennet casein protein.

Rennet casein can be produced by precipitation of pasteurized skim milk. The precipitation can be accomplished with use of an enzyme called rennin, which can be of animal or microbial origin. Methods of producing and isolating rennet casein from skim milk are well known. Precipitated rennet casein is typically washed, pressed, dried, ground, sieved, and blended to provide a homogenous powder containing approximately 80 weight percent casein protein.

The amount of casein protein included in the analogue cheese composition may be set relatively low to limit the amount of casein protein while still providing acceptable functional properties for the resultant analogue cheese. For example, the amount of casein protein included in the analogue cheese composition may be less than 5 weight percent based on the total weight of the analogue cheese composition, such as less than 3 weight percent, less than 2.5 weight percent, less than 2.25 weight percent, less than 2weight percent, less than 1.5 weight percent, less than 1.25 weight percent, less than 1 weight percent, less than 0.75 weight percent, less than 0.5 weight percent, or less than 0.33 weight percent. Indeed, in one implementation, the analogue cheese composition includes about 0 weight percent casein protein.

More commonly, however, the analogue cheese composition may include at least a minimal amount of casein protein, e.g., to impart structure and functional properties to the analogue cheese. For example, the analogue cheese composition may include at least 0.1 weight percent casein protein based on the total weight of the analogue cheese composition, such as 0.2 weight percent, 0.33 weight percent, 0.5 weight percent, 0.75 weight percent, 1 weight percent, 1.25 weight percent, 1.5 weight percent, 1.75 weight percent, or 2 weight percent. Any of these minimum casein protein levels can be combined with any of the aforementioned maximum casein protein levels to provide a target casein protein range for formulating a particular analogue cheese composition.

For example, the analogue cheese composition may include from 0.1 to 2.5 weight percent casein protein based on the total weight of the analogue cheese composition, such as from 0.2 to 2.25 weight percent, 0.25 to 2 weight percent, or 0.5 to 1 weight percent.

The analogue cheese composition may or may not also include non-casein protein, which includes non-casein dairy protein, non-dairy protein, and combinations thereof. Non-casein dairy protein includes protein naturally found in milk. Exemplary non-casein, dairy protein includes whey protein (e.g., whey protein concentrate or isolate). Suitable non-casein, non-dairy protein includes gluten protein (e.g., vital wheat gluten protein), soy protein, wheat protein, and wheat protein isolate. In certain analogues cheese compositions, non-casein, non-dairy protein can be used to make-up for shortcomings in functional properties of the cheese associated with reducing the amount of casein protein otherwise present in the analogue cheese composition.

In some implementations, the analogue cheese composition is formulated without including any non-casein protein ingredients. In other implementations, the analogue cheese composition includes one or more non-casein protein ingredients, which may be non-casein, non-dairy protein ingredients. When a non-casein protein is included in the analogue cheese composition, the non-casein protein may be used in an amount less than 10 weight percent of the total weight of the analogue cheese composition, such as less than five weight percent of the analogue cheese composition.

The analogue cheese composition can include guar gum. The addition of guar gum has been found to beneficially enhance certain functional properties of the analogue cheese composition having relatively reduced amounts of casein protein, particularly freeze/thaw stability.

Guar gum is a gel-forming galactomannan that can be obtained by grinding the endosperm portion of Cyamopsis tetragonolobus, a leguminous plant grown. Guar gum is composed of high molecular weight polysaccharides of galactomannans, which are a linear chain of (1→4)-linked β-D-mannopyranosyl units with (1→6)-linked α-D-galactopyranosyl residues as side chains. These galactose and mannose groups constitute the galactomannan portion of seed endosperm. Guar gum typically exhibits an ability to hydrate rapidly in water systems to give highly viscous solutions. The guar gum can form a viscous colloidal dispersion when completely hydrated to provide a thixotropic rheological system.

Guar gum useful for the analogue cheese composition can be GRAS (generally recognized as safe) according to 21 C.F.R. § 184.1339. The guar gum used in the composition may generally be unsubstituted guar gum, although embodiments may use a substituted guar gum in addition to or in lieu of an unsubstituted guar gum. The amount of guar gum incorporated into the analogue cheese composition can be selected based on the several factor, such as the specific amount of casein protein selected to be used in the analogue cheese and the desired functional characteristics of the resultant analogue cheese and/or pizza cheese, e.g., the firmness from the Freeze/Thaw Evaluation Cycle, and/or other test values.

When used, the amount of guar gum introduced into the analogue cheese composition may be proportional to the amount of casein protein introduced into the analogue cheese composition (e.g., with the amount of casein protein being relatively reduced). For example, a ratio of the weight of guar gum divided by the weight of casein protein provided in the analogue cheese composition may be at least 1.0, such as at least 1.2, at least 1.4, at least 1.6, at least 1.8, at least 2.0, at least 2.2, at least 2.4, at least 2.6, at least 2.8, at least 3.0, at least 3.2, at least 3.4, at least 3.6, at least 3.8, or at least 4.0.

In one specific formulation, the ratio of the weight of guar gum divided by the weight of casein protein is at least about 1.4. It is been observed that, in certain analogue cheese formulations, that the textural firmness of the analogue cheese actually reduces with increasing amounts of guar gum up to a ratio of about 1.4. The textural firmness than increases in these examples as the amount of guar gum is increased to a ratio above 1.4. In these formulations, the ratio of about 1.4 exhibits a turning point in the textural firmness data.

The amount of guar gum added to the analogue cheese composition may be limited to an upper boundary, e.g., which may be a level above which further functional property modification of the analogue cheese is not observed or is not needed to obtain a resultant cheese product having desired properties. For example, the ratio of the weight of guar gum divided by the weight of casein protein provided in the analogue cheese composition may be less than 6.0, such as less than 5.0, less than 4.4, less than 4.2, less than 4.0, less than 3.8, less than 3.6, less than 3.4, less than 3.2, less than 3.0, less than 2.8, less than 2.6, less than 2.4, less than 2.2, less than 2.0, less than 1.8, or less than 1.6. Any of these maximum guar gum levels can be combined with any of the aforementioned minimum guar gum levels to provide a target guar gum range for formulating a particular analogue cheese composition. For example, the ratio of the weight of guar gum divided by the weight of casein protein provided in the analogue cheese composition may be within a range from 1.0 to 4.0, such as from 1.4 to 3.0, from 2.0 to 4.0, or from 1.4 to 2.5.

The actual weight percentage of guar gum incorporated into the analogue cheese composition can vary depending on the amount of casein protein incorporated into the cheese composition and the relative ratio of guar gum to casein protein selected for the particular analogue cheese being formulated. The amount of guar gum may typically be within a range from 0.1 weight percent to 10 weight percent, based on the total weight of the analogue cheese composition, such as from 0.25 weight percent to 8.0 weight percent, or 0.5 weight percent to 5.0 weight percent.

The analogue cheese composition may optionally include one or more hydrocolloids other than guar gum (one or more other hydrocolloids in addition to guar gum, when guar gum is used in the composition). Typical hydrocolloids used in the food production industry are polysaccharides and proteins that can function to control, for example, the stability, texture, and/or organoleptic properties of a food product. Hydrocolloids other than guar gum that may be usefully employed in the analogue cheese composition include agar, alginate, carrageenan, gelatin, locust bean gum, pectin, xanthan gum, starch, and combinations thereof.

In some formulations, the analogue cheese composition includes at least starch as an ingredient used within the ingredient category of hydrocolloids other than guar gum. For example, when the analogue cheese composition is formulated to include one or more hydrocolloids other than guar gum, starch may provide at least 50 weight percent of the one or more hydrocolloids other than guar gum, such as at least 75 weight percent, at least 90 weight percent, or 100 weight percent.

Starch can also influence one or more of functional properties of the analogue cheese composition. When used, the starch may be pre-gelatinized, non-pregelatinized, modified, or unmodified. In some formulations, the starch incorporated into the analogue cheese composition is a non-pregelatinized, modified starch can be useful as described. As used herein a “modified” starch means that the structure of starch has been modified chemically, thermally, or by other means developed in the future, to alter the viscosity of the starch in water. One example of a non-pregelatinized, modified starch that may be used is a non-pregelatinized, thermally-inhibited starch.

As used herein, the term “non-pregelatinized” modified starch means a starch that is insoluble in cold water and appears birefringent when seen under polarized light with a microscope. Non-pregelatinized, modified starch (also known as cook-up starch) tends to gradually thicken upon heating. During one or more stages of a cheese-making process, non-pregelatinized, modified starch granules can and typically do become gelatinized. Gelatinization is a series of changes that starch undergoes when heated in excess water, which solubilizes the starch and results in increased viscosity and disappearance of birefringence. Also during one or more stages of the cheese-making process, non-pregelatinized, modified starch granules can break down or reduce in size to a certain degree as a result of one or more of heating, mixing, and shearing the granule in a cheese composition. A non-pregelatinized, modified starch that is resistant to such breakdown can tend to provide suitable viscosity characteristics during processing. The resistance to granule breakdown results in a starch granule in the final analogue cheese composition that is relatively larger in size (e.g., larger cross-sectional area) as compared to a starch granule that is not as resistant to such breakdown during processing.

When used, the one or more hydrocolloids other than guar gum may be incorporated into the analogue cheese composition in an amount from 5.0 to 30 weight percent, based on the total weight of the analogue cheese composition, such as from 10 to 25 weight percent, or from 15 to 20 weight percent. When starch is used, the starch can be procured from one or more sources such as corn, potato, sweet potato, wheat, rice, sago, tapioca, sorghum, and other plant sources.

The analogue cheese composition may typically include water. The amount of water included in the analogue cheese composition may range from 30 weight percent to 65 weight percent, based on the total weight of the analogue cheese composition, such as from 33 weight percent to 55 weight percent, or from 45 weight percent to 55 weight percent. In some formulations, water constitutes a majority weight percent of the analogue cheese composition (e.g., greater than 50 weight percent of the analogue cheese composition based on the total weight of the analogue cheese composition).

The analogue cheese composition may include one or more emulsifying salts. The addition of an emulsifying salt to the analogue cheese composition can be beneficial to hydrate the casein protein, allowing the casein protein to effectively impart desired functional properties to the analogue cheese composition. For example, an emulsifying salt may detach divalent calcium ions from the cheese matrix and replace them with monovalent sodium ions. This ionic exchange can convert the insoluble calcium paracaseinate into sodium paracaseinate, which is more soluble and functions as an emulsifier and stabilizer in the analogue cheese melt.

Exemplary emulsifying salt include monosodium phosphate, disodium phosphate, dipotassium phosphate, trisodium phosphate, sodium metaphosphate (sodium hexametaphosphate), sodium acid pyrophosphate, tetrasodium pyrophosphate, sodium aluminum phosphate, sodium citrate, potassium citrate, calcium citrate, sodium tartrate, sodium potassium tartrate, and combinations thereof.

When used, a relatively increased amount of one or more emulsifying salts may be incorporated into the analogue cheese composition having a relatively reduced amount of casein protein. Increasing the amount of emulsifying salts used in the analogue cheese composition may be useful to improve the functionality of the remaining casein protein present in the analogue cheese. For example, increasing the relative amount of emulsifying salt used in the analogue cheese composition while reducing the amount of casein protein present may cause the residual casein protein to unfold more fully in the cheese composition. As a result, the residual casein protein may impart functional properties to the analogue cheese corresponding to a higher casein protein concentration albeit at a lower level. This can allow the relative amount of casein protein present in the analogue cheese composition to be reduced while minimizing the performance degradation associated with reducing the casein protein level by increasing the amount of emulsifying salt present in the composition.

When used, the amount of emulsifying salts introduced into the analogue cheese composition may be proportional to the amount of casein protein introduced into the analogue cheese composition (e.g., with the amount of casein protein being relatively reduced). For example, a ratio of the weight of emulsifying salts divided by the weight of casein protein provided in the analogue cheese composition may be at least 1.0, such as at least 1.5, at least 2.0, at least 2.5, at least 3.0, at least 3.5, or at least 4.0.

The amount of emulsifying salts added to the analogue cheese composition may be limited to an upper boundary, e.g., which may be a level above which further functional benefit is not observed or is not needed to obtain a resultant cheese product having desired properties. Indeed, the addition of emulsifying salts may compete with guar gum, when used, limiting the amount of emulsifying salt that may be usefully employed in the analogue cheese composition. The addition of emulsifying salts may decrease the firmness of the analogue cheese, competing with the affects of the guar gum.

The ratio of the weight of emulsifying salts divided by the weight of casein protein provided in the analogue cheese composition may be less than 5.0, such as less than 4.0, less than 3.0, less than 2.5, less than 2.0, or less than 1.5. Any of these maximum emulsifying salts levels can be combined with any of the aforementioned minimum emulsifying salts levels to provide a target emulsifying salts range for formulating a particular analogue cheese composition.

The actual weight percentage of emulsifying salts incorporated into the analogue cheese composition may vary depending on the amounts of casein protein and/or guar gum incorporated into the cheese composition. When used, the amount of emulsifying salts may typically be within a range from 0.5 weight percent to 6 weight percent, based on the total weight of the analogue cheese composition, such as from 1.0 weight percent to 4.0 weight percent. In some examples, the amount of emulsifying salts may range from 0.6 weight percent to 1.8 weight percent, such as from 1.0 weight percent to 1.4 weight percent, or from 1.1 weight percent to 1.3 weight percent. In other examples, the amount of emulsifying salts may be comparatively lower, such as within a range from 0.125 weight percent to 0.375 weight percent.

Various other ingredients known in the food and cheese composition arts may be included in the analogue cheese composition. Such optional ingredients include an acidifying agent (e.g., vinegar, lactic acid, citric acid, acetic acid, and phosphoric acid), cream, milkfat, milk, salt, artificial coloring, spice, flavoring, mold-inhibitor, nutritional supplements, fiber (e.g., cellulose, oat fiber, etc.).

A pizza cheese composition according to disclosure may be manufactured by incorporating an analogue cheese composition as described herein with one or more dairy cheeses, e.g., to impart one or more cheese flavors to the finished product. The analogue cheese may be combined with the dairy cheese and a solid state, e.g., by mixing solid particles of the analogue cheese with solid particles of the dairy cheese. More typically, however, the dairy cheese may be incorporated into the analogue cheese during production when the analogue cheese is in a molten or liquidous state, thereby becoming compositionally dispersed throughout the analogue cheese to form a resultant pizza cheese that is a homogeneous blend of the dairy cheese component and the analogue cheese component.

The dairy cheese used to formulate the pizza cheese composition may be in the form of a soft cheese, a hard cheese, and/or a semi-hard cheese. In some examples, the dairy cheese is in the form of a cheese powder. Examples of one or more dairy cheeses that may be used in the pizza cheese composition include, but are not limited to, mozzarella, Parmesan, cheddar, Monterey Jack, Romano, muenster, Swiss, provolone, and combinations thereof.

When mozzarella cheese is used, the mozzarella may be a standard mozzarella, a low-moisture mozzarella, a part-skim mozzarella, and/or a low-moisture, part-skim mozzarella. Standard mozzarella has a minimum milkfat content of 45% by weight of the solids and a moisture content of more than 52% but not more than 60% by weight. Low-moisture mozzarella has a minimum milkfat content of 45% be weight of the solids and the moisture content is more than 45% but not more than 52% by weight. Part-skim mozzarella has a moisture content of more than 52% but not more than 60% by weight, and a milk fat content that is less than 45% but not less than 30% calculated on the solids basis. Low-moisture part-skim mozzarella has a moisture content of more than 45% but not more than 52% by weight and a milkfat content, calculated on the solids basis, of less than 45% but not less than 30%.

The amount of dairy cheese utilized in the pizza cheese composition may be at least 3 weight percent based on the total weight of the pizza cheese composition, such as at least 5 weight percent, at least 7 weight percent, at least 8 weight percent, at least 9 weight percent, at least 10 weight percent, at least 11 weight percent, or at least 12 weight percent. For example, the amount of dairy cheese utilized in the pizza cheese composition may range from 10.0 weight percent to 20 weight percent based on the total weight of the pizza cheese composition, such as from 10.0 weight percent to 17 weight percent, or from 12 weight percent to 17 weight percent. The weight of the dairy cheese included in the analogue cheese composition may be based on the natural cheese weight of the dairy cheese, including water present in the diary cheese.

According to this description, pizza cheese compositions containing a dairy cheese component and an analogue cheese component can be formulated with one or more desirable functional properties while utilizing a relatively reduced amount of casein protein in the analogue cheese fraction. For example, the pizza cheese composition can exhibit beneficial freeze/thaw stability. The pizza cheese composition can exhibit a textural firmness of at least 1500 grams after being subjected to a Freeze/Thaw Evaluation Cycle, such as at least 1600 g, at least 1700 g, at least 1800 g, at least 1900 g, at least 2000 g, at least 2100 g, or at least 2200 g. For example, the pizza cheese composition may exhibit a textural firmness from 1800 g to 2600 g, such as from 1900 g to 2400 g, after being subjected to a Freeze/Thaw Evaluation Cycle.

Pizza cheese compositions as described herein can be used as edible food products or can be further processed to form an edible food product. The pizza cheese composition may be formed in a block and subsequently sized reduced by cutting slices, shredding, cubing, and/or performing other size reduction process. The pizza cheese composition can be included as an ingredient or component of a food product that includes the cheese composition, such a pizza, pizza-type snack food, pizza roll, pizza pocket, “hot pockets,” sandwiches, hoagies, Italian foods such as lasagna and spaghetti, and the like, as well as cheese-stuffed foods such as jalapeno poppers. Example food product can include mozzarella substitute cheese compositions.

Pizza cheese compositions and products can be combined with other food products before being packaged. Such cheese products can be incorporated or combined with other food products in any suitable way. For example, a final cheese product can be applied in any suitable form (e.g., shredded) to another food product such as pizza. As another example, a pizza cheese can be injected in into a food product that includes cheese (e.g., snack food including pizza-type snack food and the like). A cheese composition can also be packaged, alone or in combination with other food ingredients, frozen, and stored for delayed use and consumption.

Any product containing a pizza cheese and/or analogue cheese according to the disclosure may be prepared, packaged, frozen, stored, and optionally shipped in a frozen state for commercial distribution and sale. The frozen food can be stored frozen for an extended period and eventually used by a private consumer or commercial user by heating the frozen food product (with optional thawing) in a conventional, convection, or microwave oven.

The following examples may provide additional details about cheese compositions and products according to the disclosure.

### EXAMPLES

### Example 1—Freeze/Thaw Stability

Imitation pizza cheese samples were produced that included approximately 10% low fat mozzarella cheese, 47 wt % water, 20 wt % oil, 12 wt % hydrocolloids, 1.2 wt % emulsifying salts, with varying levels of casein and guar gum. Each test sample was produced using a double auger cheese cooker. The ingredients in each sample were mixed together and then heated using live steam injection to a target temperature of approximately 175F. Once the cheese reached or passed the target temperature, the pizza cheese was dumped out of the double auger cheese cooker. The cheese was then pumped into a crate with the dimensions of a length×width×height of 18.75 inches×11.75 inches×8.5 inches tall.

Two different crates were filled with hot cheese for each sample. These crates were then placed into either a refrigerated room (36 F temperature) or a frozen room (−5 F temperature) for 24 hours. After 24 hours, the sample placed in the frozen room was taken out of the frozen room and placed in the refrigerated room. Both blocks of cheese were then left in their respective crates in the refrigerated room for 3 days to allow the temperature of the blocks to equilibrate to the refrigerated temperature. After the 3-day period, both blocks of cheese for each sample (the block originally placed in the refrigerated room and the block initially placed in the frozen room and subsequently transferred to the refrigerated room) were taken and analyzed using a Texture Analyzer.

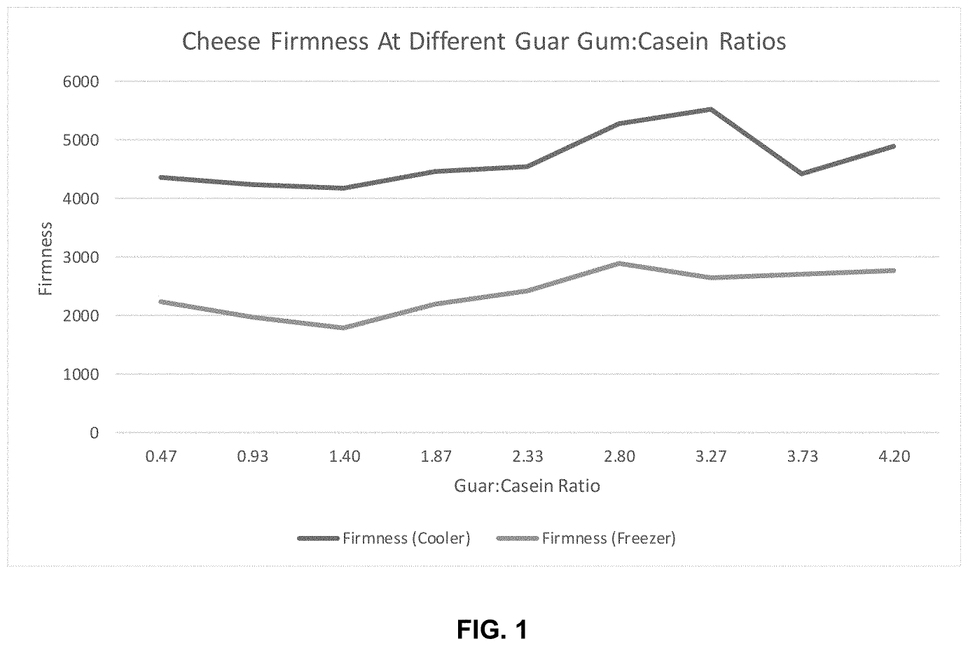

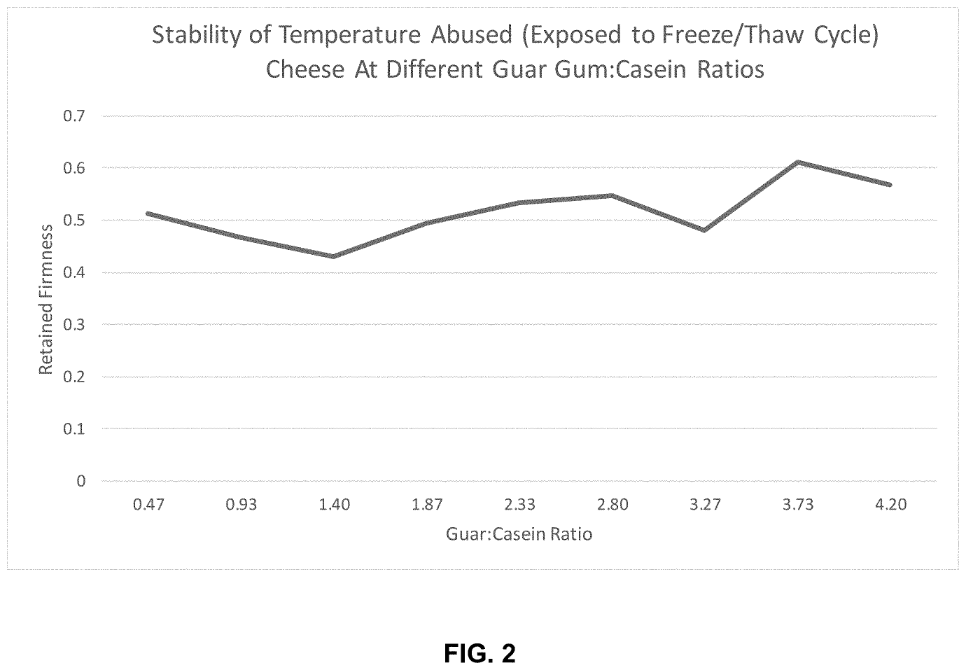

The method used to analyze the samples was the compressibility test protocol described above under the definition of Freeze/Thaw Evaluation Cycle, which provided textural firmness force measurements. Different samples of imitation cheese were formulated using different ratios of casein to guar gum to create the data shown in FIGS. 1 and 2. FIG. 1 shows the textural firmness of the cheese in grams relative to the weight ratio of guar gum divided by casein protein for each sample stored in both the refrigerated room and the frozen room. FIG. 2 shows the ratio of retained firmness for each sample after relative to the weight ratio of guar gum divided by casein protein. Retained firmness is the measured firmness of the freezer cheese block divided by the measured firmness of the refrigerator cheese block for each sample.

The data show reduced firmness, particularly retained firmness, with an increasing guar gum to casein ratio until a ratio of approximately 1.4 is reached. Increasing the guar gum to casein ratio above 1.4 results in increasing firmness, including retained firmness, with a local maxima observed at a ratio of approximately 2.8.

### Example 2—Retained Firmness

Imitation pizza cheese samples were produced that included approximately 10% low fat mozzarella cheese, 47 wt % water, 20 wt % oil, 12 wt % hydrocolloids, 1.2 wt % emulsifying salts, with different types of hydrocolloids known to help with freeze and thaw stability. Each sample was produced using a double auger cheese cooker. The ingredients for each sample were mixed together and then heated using live steam injection to a target temperature of approximately 175 F. Once the cheese reached or passed the target temperature the pizza cheese was dumped out of the double auger cheese cooker. The cheese was then pumped into a crate with the dimensions of a length×width×height of 18.75 inches×11.75 inches×8.5 inches tall.

Two different crates were filled with hot cheese for each sample. These crates were then placed into either a refrigerated room (36 F temperature) or a frozen room (−5 F temperature) for 24 hours. After 24 hours, the sample placed in the frozen room was taken out of the frozen room and placed in the refrigerated room. Both blocks of cheese were then left in their respective crates in the refrigerated room for 3 days to allow the temperature of the blocks to equilibrate to the refrigerated temperature. After the 3-day period, both blocks of cheese for each sample (the block originally placed in the refrigerated room and the block initially placed in the frozen room and subsequently transferred to the refrigerated room) were taken and analyzed using a Texture Analyzer.

The method used to analyze the samples was the compressibility test protocol described above under the definition of Freeze/Thaw Evaluation Cycle, which provided textural firmness force measurements. Different samples of imitation cheese were formulated using different hydrocolloids to determine their ability to retain firmness after a freeze and thaw cycle. Table 1 below show the results of the experiment. The results in this table are the average of multiple production runs. In the table, formulations listed as High Casein contained 2.5 wt % casein; formulations listed as Low Casein has less than 1 wt % casein.

### Table 1: Comparison of Control Cheese and Cheese with Several Freeze/Thaw Stabilizing Agents

| | % Firmness Retained through |
|---|---|
| Sample description | Freeze/Thaw Cycle |
| High Casein | 55.26 |
| Low Casein | 40.58 |
| Low Casein Modified High Gel Strength | 37.05 |
| Corn Starch | |
| Low Casein Cross Linked Waxy Maize | 48.78 |
| Starch | |
| Low Casein Modified Waxy Maize | 59.50 |
| Low Casein Modified Waxy Maize | 53.42 |
| Different Variety | |
| Low Casein Guar Gum | 63.62 |

The data show that the imitation cheese composition formulated with guar gum as a hydrocolloid performed unexpectedly better at maintaining the firmness of the cheese after freezing compared to similar formulations with different types of hydrocolloids known to help with freeze and thaw stability. Indeed, the imitation cheese composition formulated with guar gum and low casein preformed even better than a baseline high casein imitation cheese formulation.

### Example 3—Emulsifying Salt Data

Imitation pizza cheese samples were produced that included approximately 10% low fat mozzarella cheese, 47 wt % water, 20 wt % oil, 12 wt % hydrocolloids, 0.35 wt % guar gum, and different levels of emulsifying salts. Each test sample was produced using a Thermomixer®. The ingredients for each sample were mixed together and then heated using the heating function on the mixer to a target temperature of approximately 180 F. Once the cheese reached or passed the target temperature, the pizza cheese was dumped out of the Thermomixer®. The cheese was dumped into a circular sample container of approximately 8 ounces in size capacity. The sample was then placed into a refrigerator for 3 days.

After the 3-day period, each sample was analyzed using a texture analyzer. The method used to analyze the samples was the compressibility test protocol described above under the definition of Freeze/Thaw Evaluation Cycle, which provided textural firmness force measurements. Different samples of imitation cheese were formulated using different levels of emulsifying salts to quantify the impact of the ingredient on the cheese. This testing was conducted using a factorial design, so the impact of each individual ingredient could be measured along with any interactions.

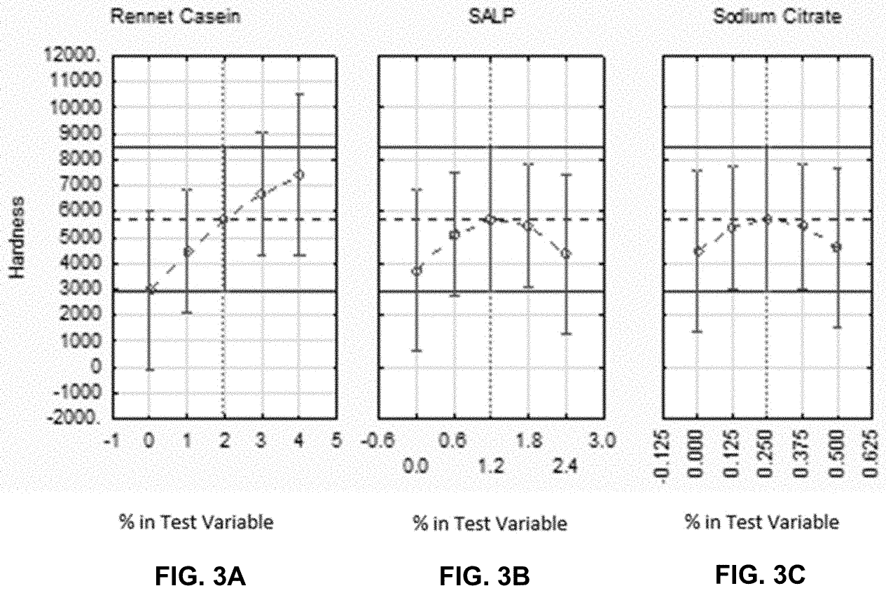

FIGS. 3A-3C are graphs illustrating the results of experiment modifying the amount of emulsifying salts added to the pizza cheese. The Y-axis in each graph is textural firmness in grams. The X-axis in each graph indicates the relative concentration of the noted component added to the formulation, increasing from left to right. FIG. 3A illustrates that addition of casein increased firmness with each additional amount of casein added. FIGS. 3B and 3C illustrate textural firmness when using sodium aluminum phosphate (SALP) and sodium citrate, respectively, as the emulsifying salt. These data show that the emulsifying salts independently increased the firmness of the cheese up to a maximum but started to soften the cheese at the midpoint of each emulsifying salts tested levels in the design.

1. A pizza cheese composition comprising:
(a) a dairy cheese comprising at least 10 weight percent of the pizza cheese composition; and
(b) an analogue cheese comprising:
(i) fat ranging from 15 to 35 weight of the analogue cheese, the fat being extracted from a non-dairy source;
(ii) casein protein in an amount less than 3 weight percent of the analogue cheese;
(iii) guar gum; and
(iv) a hydrocolloid other than guar gum ranging from 10 to 25 weight percent of the analogue cheese,
wherein a ratio of a weight of guar gum divided by a weight of casein protein is at least 1.0.

2. The pizza cheese composition of claim 1, wherein the ratio of the weight of guar gum divided by the weight of casein protein ranges from 1.0 to 4.0.

3. The pizza cheese composition of claim 1, wherein the ratio of the weight of guar gum divided by the weight of casein protein ranges from 1.4 to 2.5.

4. The pizza cheese composition of claim 1, wherein casein protein ranges from 0.25 to 2 weight percent of the analogue cheese.

5. The pizza cheese composition of claim 1, wherein the amount of casein protein is less than 1.5 weight percent of the analogue cheese.

6. The pizza cheese composition of claim 1, wherein the analogue cheese further comprises water ranging from 30 to 60 weight percent of the analogue cheese.

7. The pizza cheese composition of claim 1, wherein the analogue cheese further comprises an emulsifying salt ranging from 1 to 4 weight percent of the analogue cheese.

8. The pizza cheese composition of claim 7, wherein a ratio of a weight of emulsifying salt divided by a weight of casein protein ranges from 2 to 4.

9. The pizza cheese composition of claim 1, wherein the hydrocolloid other than guar gum comprises at least 75 weight percent starch.

10. The pizza cheese composition of claim 1, wherein:
fat ranges from 20 to 30 weight percent of the analogue cheese;
the amount of casein protein is less than 2 weight percent of the analogue cheese;
the hydrocolloid other than guar gum ranges from 12 to 17 weight percent of the analogue cheese, and
the analogue cheese further comprises water ranging from 33 to 55 weight percent of the analogue cheese and an emulsifying salt ranging from 1 to 4 weight percent of the analogue cheese.

11. The pizza cheese composition of claim 1, wherein the dairy cheese consists essentially of mozzarella.

12. The pizza cheese composition of claim 1, wherein the dairy cheese comprises less than 12 weight percent of the pizza cheese composition and the analogue cheese comprises greater than 88 weight percent of the pizza cheese composition.

13. The pizza cheese composition of claim 1, wherein the pizza cheese composition exhibit a textural firmness of at least 1800 g after being subjected to a Freeze/Thaw Evaluation Cycle.

14. The pizza cheese composition of claim 1, wherein the pizza cheese composition is diced.

15. A packaged food product comprising a pizza cheese composition according to claim 1.

16. The packaged food product of claim 1, wherein the packaged food product is a frozen food selected from the group consisting of a pizza, a pizza roll, and a pizza pocket.

17. A pizza cheese composition comprising:
(a) a dairy cheese comprising from 10 to 20 weight percent of the pizza cheese composition; and
(b) an analogue cheese comprising from 80 to 90 weight percent of the pizza cheese composition, the analogue cheese comprising:
(i) fat ranging from 15 to 35 weight of the analogue cheese, the fat being from a non-dairy source;
(ii) casein protein in an amount less than 3 weight percent of the analogue cheese;
(iii) guar gum;
(iv) a hydrocolloid other than guar gum ranging from 10 to 25 weight percent of the analogue cheese, the hydrocolloid comprising at least 75 weight percent of a starch;
(v) water ranging from 33 to 55 weight percent of the analogue cheese; and
(vi) an emulsifying salt,
wherein a ratio of a weight of guar gum divided by a weight of casein protein is at least 1.0, and
a ratio of a weight of emulsifying salt divided by a weight of casein protein ranges from 2 to 4.

18. The pizza cheese composition of claim 17, wherein:
fat ranges from 20 to 30 weight percent of the analogue cheese;
the amount of casein protein is less than 2 weight percent of the analogue cheese;
the hydrocolloid other than guar gum ranges from 12 to 17 weight percent of the analogue cheese, and
the emulsifying salt ranges from 1 to 3 weight percent of the analogue cheese.

19. The pizza cheese composition of claim 17, wherein the pizza cheese composition exhibit a textural firmness of at least 1800 g after being subjected to a Freeze/Thaw Evaluation Cycle.

20. The pizza cheese composition of claim 17, wherein the ratio of the weight of guar gum divided by the weight of casein protein is greater than 1.4.
